(19) United States
(12) Patent Application Publication
(10) Pub. No.: US 2002/0018055 A1
(43) Pub. Date: Feb. 14, 2002

(54) Substraight positioning device and method

(76) Inventors: James David Smith, Etobicoke (CA); Enrico Ugis Villa, Toronto (CA)

Correspondence Address: Isis E. Caulder, Bereskin & Parr, Box 401, 40 King Street West, Toronto, ON, M5H 3Y2, CA

(21) Appl. No.: 09/874,245

(22) Filed: Jun. 6, 2001

Related U.S. Application Data
(60) Provisional application No. 60/209,592, filed on Jun. 6, 2000.

(51) Int. Cl. G09G 5/00

(52) U.S. Cl. 345/204

(57) ABSTRACT

A substrate positioning device for use with a scrollable display utilizes reflective and transmissive optical sensors to detect the presence of frame markers at the top and bottom of display art frames and a rotary encoder to determine the rotary position of the substrate storage tube at particular positions along the display art. A controller is used to recieve sensor input data from optical sensors and rotary encoder to determine the relationship between the position of the substrate and the rotary position of the substrate storage tube. The specific relationship between the position of the display art and the rotary position of the substrate storage tube is maintained and periodically updated to ensure correct positioning of display art within the scrolling display. Using this relationship it is possible to predict the position of the display art based soley on the rotary position of the substrate storage tube alone. This technique is especially useful in the case where frame markers are obscured or damaged through use. Accordingly the device does not depend on the longevity and physical condition of the frame markers for proper operation.

This application claims priority from U.S. Provisional Patent Application No. 60/209,592 filed Jun. 6, 2000.

### FIELD OF THE INVENTION

This invention relates to a substrate positioning device and method and more particularly to a device and method which allows for the determination of the relationship between the position of the substrate and the rotary position of the display roller.

### BACKGROUND OF THE INVENTION

Commercially available prior art advertising displays include fixed billboard signs, vertically rotating multi-element signs, and more recently high definition LED and plasma screens. All of these types of displays suffer from different practical disadvantages. Fixed billboard signs can only provide one advertising display at a time and requires a complete reinstallation of advertising display each time. Rotating multi-element signs provide images which contain a number of vertical lines where the elements interface and results in a less than aesthetically pleasing result. High definition LED and plasma display screens suffer from a preferred viewing angle and quickly lose visual impact when viewed from peripheral angles.

Scrollable displays overcome a number of shortcomings associated with other types of prior art displays, by providing the ability to display a large number of display art (i.e. can display a substantial number of advertisements using one suitably formatted web roll), the ability to provide a number of images without having to segment the images in order to place them on rotatable elements, and the ability to provide strong visual effect for the display over a wide range of viewing angles. However, existing scrolling web changeable display signs still have a number of operational disadvantages which can detract from their effectiveness as an advertising vehicle.

In order to be visually effective, scrollable displays must transport display art frames into the display area as smoothly as possible and with as little positional error as possible. However, system over-runs are common. Specifically, in many scrollable displays, the substrate web is unexpectedly rolled too far and disconnects from the storage tubes causing catastrophic damage. Also, scrollable displays suffer from misalignment difficulties due to cumulative shifting of display art on substrate over the course of operation, and misdetection of display art frames which can result in miscues and operational errors.

### SUMMARY OF THE INVENTION

The present invention provides a substrate positioning device for positioning a substrate within a substrate scrolling display having a display window, a substrate storage tube for storing the substrate and a motor driver coupled to the substrate storage tube for scrolling the substrate, such that a display art frame on the substrate is positioned within the display window, said substrate positioning device comprising:

(a) a rotary encoder coupled to the substrate storage tube for detecting the rotary position of the substrate storage tube;

(b) a controller coupled to said rotary encoder comprising:

(i) a memory for storing the rotary position of the substrate storage tube that corresponds to the position of the substrate when the display art frame is positioned within the display window;

(ii) a processor coupled to said memory programmed to access said rotary position in response to a request to display the display art frame within the display window;

(c) a display interface coupled to said controller for instructing the motor driver to rotate the substrate storage tube such that the display art frame is positioned within the display window.

The present invention also provides method for positioning a substrate within a substrate scrolling display having a display window, a substrate storage tube for storing the substrate and a motor driver coupled to the substrate storage tube for scrolling the substrate, said method comprising the steps of:

(a) providing a substrate with a display art frame within said substrate scrolling display;

(b) storing the rotary position of the substrate storage tube that corresponds to the position of the substrate when the display art frame is positioned within the display window;

(c) retrieving said rotary position in response to a request to display the display art frame within the display window;

(d) adjusting the rotary position of the substrate storage tube such that the display art frame is positioned within the display window.

The present invention also provides a display art substrate assembly for use within a scrolling substrate display, said display art substrate assembly comprising:

(a) a substrate having a first coefficient of expansion and a first resistance to deformation, said substrate being adapted to be moveable within said scrolling display; and

(b) a removeable display art sheet for attachment to said substrate, said removeable display art sheet having a second coefficient of expansion which is substantially equal to the first coefficient of expansion of said substrate and a second resistance to deformation which is substantially equal to the first resistance to deformation of said substrate;

such that when said removeable display art sheet is brought into close contact with said substrate, substantially identical stresses are produced within said substrate and said removable display art sheet and substantial cling adhesion is produced therebetween.

### BRIEF DESCRIPTION OF THE DRAWINGS

In the accompanying drawings:

FIG. 1 is a block diagram of the substrate positioning device according to the present invention;

FIG. 2 is a diagram showing a perspective view of a substrate having position markers of the substrate positioning device of FIG. 1

FIG. 3 is a block diagram of hardware components of the substrate positioning device of FIG. 1;

FIG. 4 is a block diagram illustrating the hardware components of the network interface of the substrate positioning device of FIG. 1;

FIG. 5 provides a representation of the kinds of data tables which are maintained within FRAME MARK POSITION table by the microcontroller of the substrate positioning device of FIG. 1;

FIG. 6 is a flowchart of the FRAME SEEKING routine executed by the microprocessor of the substrate positioning device of FIG. 1;

FIG. 7 is a flowchart of the VALID FRAME MARK PAIR routine executed by the microprocessor of the substrate positioning device of FIG. 1;

FIG. 8 is a flowchart of the END OF SCROLL DETECTION routine executed by the microprocessor of the substrate positioning device of FIG. 1;

FIG. 9 is a flowchart of the CUMULATIVE POSITION ERROR CORRECTION routine executed by the microprocessor of the substrate positioning device of FIG. 1; and

FIGS. 10A, 10B, 10C and 10D are schematic diagrams illustrating the operation of another preferred method of assembling display art onto a substrate according to the invention.

### DETAILED DESCRIPTION OF THE INVENTION

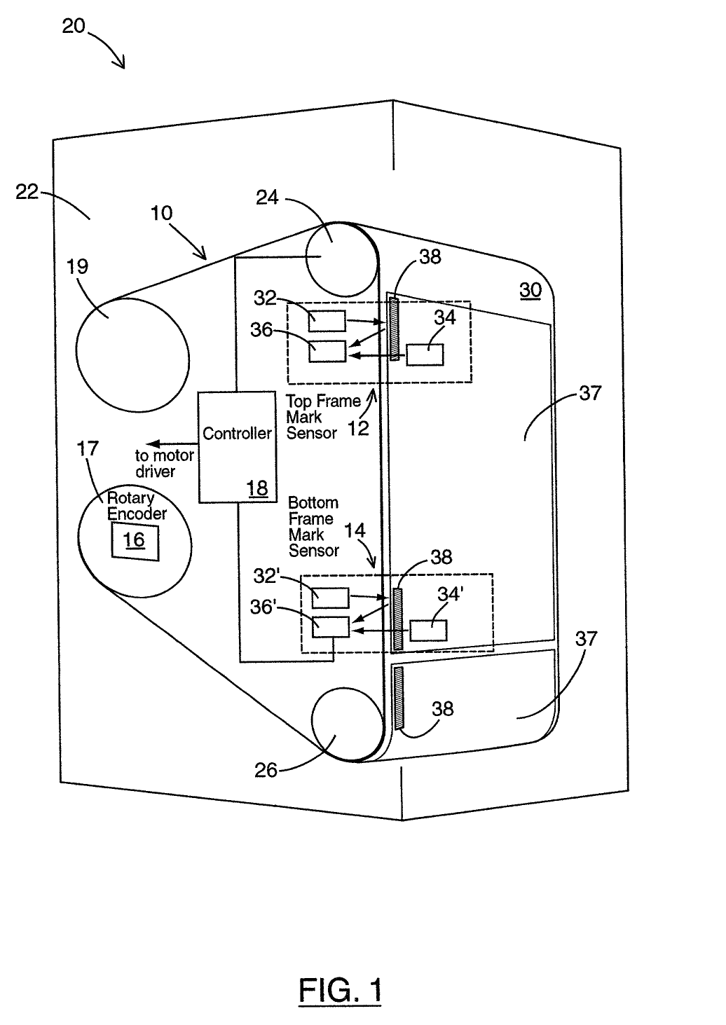

Referring to FIG. 1, illustrated therein is a substrate positioning device 10 made in accordance with a preferred embodiment of the present invention. Substrate positioning device 10 includes two frame mark sensors a top frame sensor 12 and a bottom frame sensor 14, a quadrature rotary encoder 16, and a controller 18. Substrate positioning device 10 is adapted for use within a conventional scrolling changeable display sign 20 having substrate storage tubes 17 and 19, display frame 22, top web roller 24, bottom web roller 26 and a substrate 30 that travels between rollers 24 and 26. Display art 37 can be installed on substrate 30 and contains frame markers 38 to indicate the top and bottom edges of each display art 37 frame. Substrate positioning device 10 uses frame sensors 12 and 14 and rotary encoder 16 (located in one of the storage tubes 17 or 19) to determine the relationship between the position of display art 37 on substrate 30 (i.e. by locating frame markers) and the rotary position of a storage tube 17, as will be described.

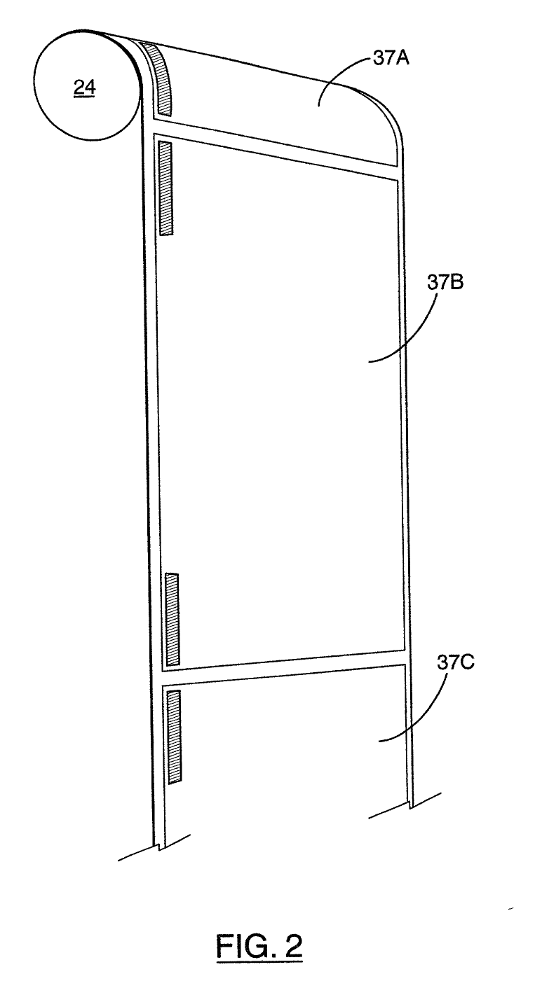

Display art 37 mounted on substrate 30 travels between rollers 24 and 26 of changeable display 20 such that the edge of the display art 37 is positioned between the second emitter 34 and receiver 36. Frame markers 38, or opaque black marks are positioned along the edge of display art 37 at the top and bottom frame edges of display art 37 on substrate 30 (see FIG. 2). All frame markers 38 are spaced an equal distance apart with the display area of each frame of display art 37 falling exactly between adjacent marks. Frame markers 38 are utilized to track the position of display art 37 and to ensure that display art 37 is appropriately provided within a “display area” having a height as illustrated on FIG. 1 as A. Accordingly, it is necessary to move substrate 30 within display frame 22 such that frame markers 38 of display art 37 are properly positioned and such that display art 37 is displayed within the display area (i.e. must appear along length A). While it is preferred to utilize frame markers 38 to indicate the presence of display art 37 directly therebetween, it should be understood that frame markers 38 can be positioned anywhere along the extent of substrate 30 and that they can be used to accurately indicate the position of any section of substrate 30 (i.e. in proximity to the frame markers 38 or otherwise).

Top frame sensors 12 and bottom frame sensor 14 each consist of a first and a second infrared emitter 32 and 34 and an infrared receiver 36 positioned in relation to substrate 30 so that a first emitter 32 operates in reflective mode and the second emitter 34 operates in transmission mode in relation to receiver 36. Infrared emitters 32 and 34 can be any commercially available plastic infrared emitting diodes such as the GaAs Infrared Light Emitting Diode LN58 manufactured by Panasonic. Similarly, infrared receiver 36 can also be any commercially available object sensors such as the Photologic Object Sensors OPB770N manufactured by Optek. It has been observed that the redundancy inherent in operating first emitter 32 in reflective mode and second emitter 34 in transmission mode improves reliability of detection, as will be described. To ensure adequate positional resolution, rotary encoder 16 is selected to provide a particular number of pulses per revolution (e.g. to provide 400 or more pulses between frame markers 38 in order to provide positional resolution that is attractive for commercial art display applications.

When a frame marker 38 falls in the proximity of the infrared receiver 36, marks 38 prevent infrared light transmitted by the second emitter 34 from passing through to receiver 36. Marks 38 also prevents infrared light from passing from first emitter 34 from reflecting to receiver 36. If display art 37 is printed on a white backing, infrared sensing is primarily reflective. If display art 37 is printed on a clear backing, then infrared sensing is primarily direct (straight-through) or transmissive. If display art 37 contains large areas of black printed along the edge normally used for frame markers 38, an ink must be used that passes infrared light and in such a case infrared sensing would be primarily direct or transmissive. Marks 38 must be large enough to ensure that they are never missed by frame sensors 12 and 14. It has been determined that it is preferably to use frame marks 38 with a ¾ inch height for a 36 inch display area. In such a case, the frame mark 38 is 1/48 of the overall frame area. This scheme limits frame position accuracy to +/−⅜ inch, or approximately 1% of overall display frame size. While this is generally acceptable, increased accuracy is possible through software-based accuracy enhancement techniques, as will be described.

In most cases, the redundancy of the two simultaneous detection techniques utilized by substrate positioning device 10 improves the reliability of mark detection and overcomes problems caused when display art 37 moves in the roller pick up area (which is a common occurrence during fast starts and stops). In addition, it is contemplated that modulated infrared emission can be utilized within substrate positioning device to further reduce the erroneous detection of stray infrared from sunlight, incandescent lighting, and other nearby sources. Another approach to avoid such interference is to use appropriately shielding physical covers.

Quadrature rotary encoder 16 is preferably mounted within one of substrate storage tubes 17 and 19 to measure the rotary position of substrate 30. Rotary encoder 16 increments according to the number of web revolutions. Rotary encoder 16 can be any conventional mechanical rotary encoder such as ECO Series encoder manufactured by Bourns. Rotary encoder 16 increments a significant number of counts from frame to frame on substrate 30. The outer diameter of the web roll within substrate storage tube 17 changes as it fills with substrate 30, thus the number of increments comprising one frame motion is not consistent from frame to frame.

Further, because the thickness of display art 37 may not be consistent along the length of substrate 30, the number of encoder counts from frame to frame cannot be easily predicted (i.e. a non-linear and irregular relationship). Accordingly, it is necessary to provide a way of calibrating the movement of the web rolls 24 and/or 26 in association with the top and bottom of frames of display art 37 as positioned on substrate 30.

As discussed, frame markers 38 are positioned at the top and bottom of frames of display art 37 on substrate 30 (FIG. 2). All frame markers 38 are spaced an equal distance apart with the display area of each frame of display art 37 falling exactly between adjacent marks. Substrate positioning device 10 is designed to indicate the presence of a valid frame of display art 37 when both frame sensors 12 and 14 have detected a frame marker 38 (as shown in FIG. 1). This introduces a level of redundancy which ensures that opaque obstructions (e.g. dirt, dark printing, etc.) in the middle of display art 37 will not cause the detection of a false frame position.

The size of frame markers 38 must be large enough to allow frame sensors 12 and 14 to detect them during a small number of increments of rotary encoder 16 (the exact number will vary for reasons described previously). The top mark of the top frame and the bottom mark of the bottom frame of display art 37 on scrolling substrate 30 are greater in length than the other frame markers 38, so that their respective frame sensors 12 and 14 will detect the absence of infrared light for a prolonged period of time during the motion of substrate 30 through rollers 24 and 26.

Controller 18 is preferably a conventional EPROM based micro controller such as the 8-bit CMOS EPROM Microcontroller Part No. PIC17C7XX, manufactured by Microchip Technology Inc. Controller 18 receives data inputs from frame sensors 12 and 14 and rotary encoder 14 and executes built-in logic routines to decode this sensed data to determine the relative motion of substrate 30 and either top roller 24 or bottom roller 26.

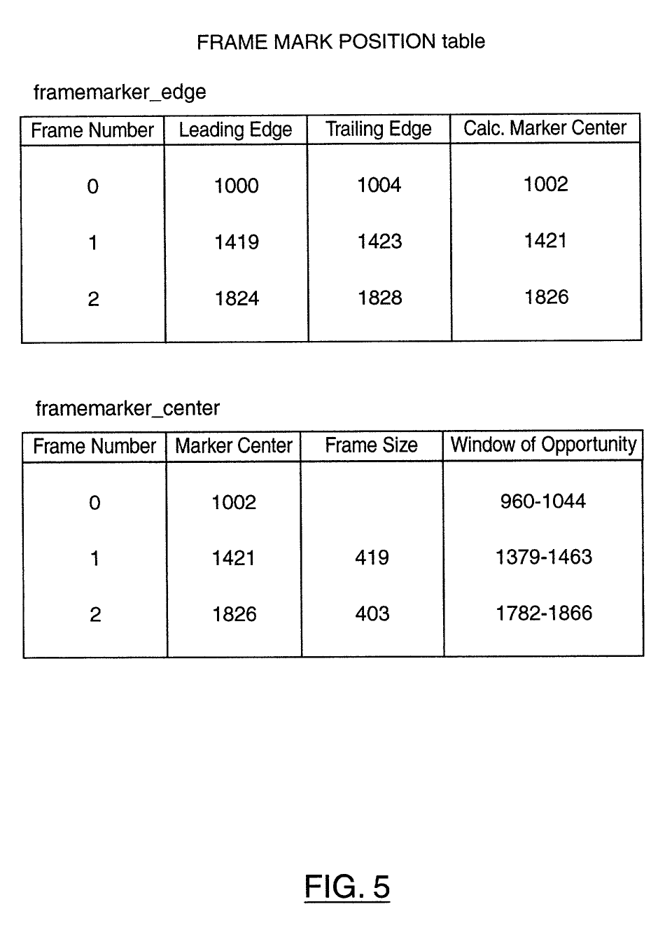

Controller 18 is capable of decoding the quadrature output of rotary encoder 16 to detect motion and direction of substrate 30. At any given time, controller 18 represents the position of the tube as an absolute number which increments when the substrate tube (not shown) rolls forward and decrements when the tube rolls backwards. During a learning process, which will be described in detail, controller 18 creates a FRAME MARKER POSITION table (see FIG. 5). The learning process starts by running substrate 30 all the way from top to bottom within display 20 and saving the rotary encoder tube position value in a unique memory location (i.e. a table entry) each time a frame marker 38 is encountered by frame sensors 12 and 14. Whenever display art 37 is changed on substrate 30, the FRAME MARKER POSITION table is reconstructed using this learning process As described, positional accuracy is improved in device 10 with additional software techniques. When device 10 is setup, microcontroller 50 executes the learning software procedure and runs substrate 30 from top to bottom. During this process, rotary-encoder position integers are saved in the multidimensional FRAME MARKER POSITION table (FIG. 5) including leading edge positions of each frame mark, trailing edge positions of each frame mark, and total number of frames found (total number of elements in each dimension of the table). The microcontroller 50 saves the described rotary encoder positions in EPROM 52 each time a frame marker pair is encountered and processed. The learning process must be initiated during new machine setup and whenever the positional relationships between frames may have changed, (e.g. after installing new art material).

Microcontroller 50 uses these learned values to calculate additional data and then stores this additional data in the FRAME MARK POSITION table. Specifically, microcontroller 50 calculates interpolated frame mark center position, the number of encoder increments between each adjacent frame mark center and the maximum anticipated cumulative error, expressed in encoder increments, for each frame mark center. This is the “window of opportunity” for detecting frame marks. The data in the FRAME MARK POSITION table created by the learning process enables the system to lookup the ABSOLUTE POSITION INTEGER of any frame number for use by the servo process. Also, accumulated positional error can be avoided by adjusting the CURRENT POSITION INTEGER value to the known position of the frame marks when valid marks are detected. It is possible to stop in the center of frame marks to provide the positional accuracy of the rotary encoder, not limited by the resolution of the frame mark size. Also, it is possible to ignore “false” frame marks when substrate 30 is not in the vicinity of a real frame mark. This reduces vulnerability to random optical opacities caused by dirt, debris, or the art printing process.

Each time rotary encoder 16 increments (caused by the rotation of the substrate storage tube and the motion of display art 37), a logic level state change is detected by controller 18 and the outputs of the two frame sensors 12 and 14 are checked. Frame markers 38 are sized so that a minimum of three encoder increments will occur between detection of valid frame markers 38 by frame sensors 12 and 14. If substrate 30 is rolled past either end of display art 37 (i.e. lower than the bottom frame or higher than the top frame), the longer frame markers 38 are detected by a single frame sensor 12 or 14. Specifically, a long top frame marker is detected if the frame is running past the top and the bottom marker is detected if the frame is running past the bottom.

During normal operation (i.e. not during the learning process), controller 18 polls for detection of frame markers 38 within a specific tolerance of the expected position. Typically, this tolerance is=+/−10% of the position stored in memory during the learning position. Controller 18 ensures that frame positioning is keyed to frame markers 38 in order to eliminate cumulative error, as will be further described. When a valid frame marker 38 (i.e. a redundant pair as previously described) is detected within the window of opportunity, the absolute position of substrate 30 is corrected to the known position of the encountered frame marker 38. This known position is one of the elements previously saved in the FRAME MARK POSITION table. This correction process can occur at any speed and occurs regardless of whether or not the detected frame mark is the final destination of a movement that is underway. Thus, in a motion from frame two to frame five, for example, the system has the opportunity to correct absolute position three times, at the frame marks for frames three, four and five.

During normal unattended operation, the frame seeking process depends only on absolute rotary encoder positions. Thus, if frame markers 38 are worn or damaged during prolonged operation of substrate positioning device 10, frame seeking will still be executed successfully. The absolute position of substrate 30 will be corrected when valid frame markers 38 are detected during normal operation, but acceptable performance will still result if the frame markers 38 are not detected in some cases. All frame markers 38 must be functional for the learning process to complete successfully, but are not subsequently required during normal operation of substrate positioning device 10. The learning process is only executed under operator supervision, which provides opportunity for correction of damaged frame markers at that time.

The preferred dimensions of substrate positioning device 10 depend on the dimensions of display 20 and length of substrate 30 utilized. Typically, a roll of substrate 30 installed in display 20 can have a length between 42 and 133 feet. A longer roll of substrate 30 can carry more images, up to a maximum of 32 separate display art 37 images per sign in current commercial versions of this device. There is no theoretical limit to the number of frames that can be processed using the described techniques. Display frame 22 has a maximum width of 6 feet wide and a minimum width of 2 feet wide using commercially available substrate and art panel materials. There is no theoretical limitation to the size of the display area using the described techniques. Storage tube 17 has an empty diameter (i.e. without substrate 30 loaded) of 3.5 inches and the display area (i.e. A in FIG. 1). Since rotary encoder 16 provides 128 pulses per revolution, the typical positional resolution achievable by device 10 with a 36 inch high display window is 128 (36/(3.5*pi)), which is 419 rotary encoder increments. This provides suitable resolution for accurate and feasible operation.

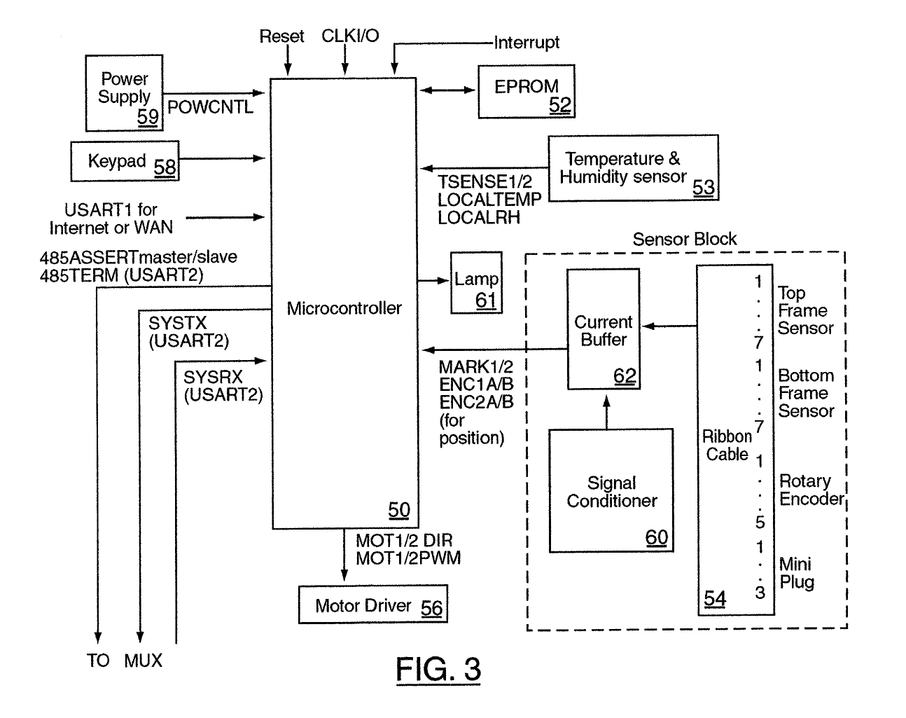

FIG. 3 is a block diagram illustrating the main hardware components of substrate positioning device 10. Specifically, controller 18 is comprised of microcontroller 50 and utilizes EPROM memory 52. Microcontroller 50 is connected to the top frame sensor 12, bottom frame sensor 14, and rotary encoder 16 (all shown in FIG. 1) via the lines: MARK 1, MARK 2, ENC1A, and ENC1B [not currently used for the frame sensing process] in order to receive information through ribbon cable 54 from the top frame sensor 13, bottom frame sensor 14 and rotary encoder 16 regarding the position of each frame marker 38.

Microcontroller 50 is also connected to temperature and humidity sensors 53 via the lines TSENSE1 and TSENSE2, LOCALTEMP and LOCALRH, which are located in the chassis of display 20. The temperature and humidity sensors are used to determine the temperature and relative humidity within display 20 and are installed directly on the logic card and allows microcontroller 50 to determine the temperature and relative humidity within substrate positioning device 10. The highest and lowest values are read into EEPROM 52, and at any time, the highest, lowest, or current reading for either the temperature or humidity can be requested.

Microcontroller 50 is connected to a conventional motor driver 56 and drives motor driver 56 directly via the lines: MOT1PWM, MOT2PWM, MOT1DIR, MOT2DIR. Microcontroller 50 is also connected to a conventional power supply 59 and to an array of lamps 61 for providing visual indications to the user regarding the operation of device 10.

In order for microcontroller 50 to communicate with the user, it also has two Universal Synchronous Asynchronous Receiver Transmitter (USART) connections, The USART1 connections allow for data exchange via the Internet and/or WAN, and the USART2 connections allow for RS232 or RS485 LAN and local control. The USART2 connections consist of 5 lines: SYSRX, SYSTX, 485TERM, 485ASSERTmaster, and 485ASSERTslave. The first two allow the microcontroller to receive incoming data (SYSRX) as well as to transmit data to other devices (SYSTX) via 3 types of connections: RS485 network, radio modem or direct PC connection, and handheld diagnostic controller. Microcontroller 50 also interfaces with a keypad 58, used for manual control and diagnostics, through the use of a latch. In addition, microcontroller 50 allows for interrupts and can be reset via the RESET line. The SHUTDOWN line allows microcontroller 50 to disable the motor driver 56 if inappropriate or undesirable operation is detected, as might result from a component failure within the motor driver 56 hardware.

Chassis ribbon cable connector 54 connects the top frame sensor 12, bottom frame sensor 14, rotary encoder 16, and mini plug RS232 port back to the controller. The mini plug port is one of several ports used by microcontroller 50 to send data to and receive data from other devices. The sensor and encoder information is buffered and transmitted to the microcontroller via data lines MARK1, MARK2, ENC1B, ENC1A, ENC2A, and ENC2B. The sensor signals connected directly to microcontroller 50 are conditioned using a surge-suppression circuit 60 (i.e. a conventionally known zener diode array) and a current buffer 62.

Rotary encoder 16 is responsible for measuring the current position (i.e. motion and direction) of the substrate storage tube 17. Rotary encoder 16 presents its output to microcontroller 50 in quadrature form, and the firmware subsequently decodes the quadrature output of the rotary encoder and provides a binary bit for direction of rotation and a pulse for each passage of a specified angle of rotation. These signals are then translated into an integer value ABSOLUTE POSITION INTEGER which represents the position of the web material, as will be discussed.

Top frame sensor 12 locates the frame marker on the top of each display art 37 and bottom frame sensor 14 locates the frame marker at the bottom of the display art 37. Top and bottom frame sensors 12 and 14 can produce either inverted or non-inverted output. If, for example, an inverting output is selected, the digital output of the sensor transitions from low to high when the sensor first detects an opaque non-reflective frame marker 39. When the frame marker 38 moves away from the sensor, the output then transitions from high to low. Microcontroller 50 notes the various positions of rotary encoder 16 when each of these transitions occurs and subsequently calculates the rotary encoder position that corresponds to the center of frame marker 38.

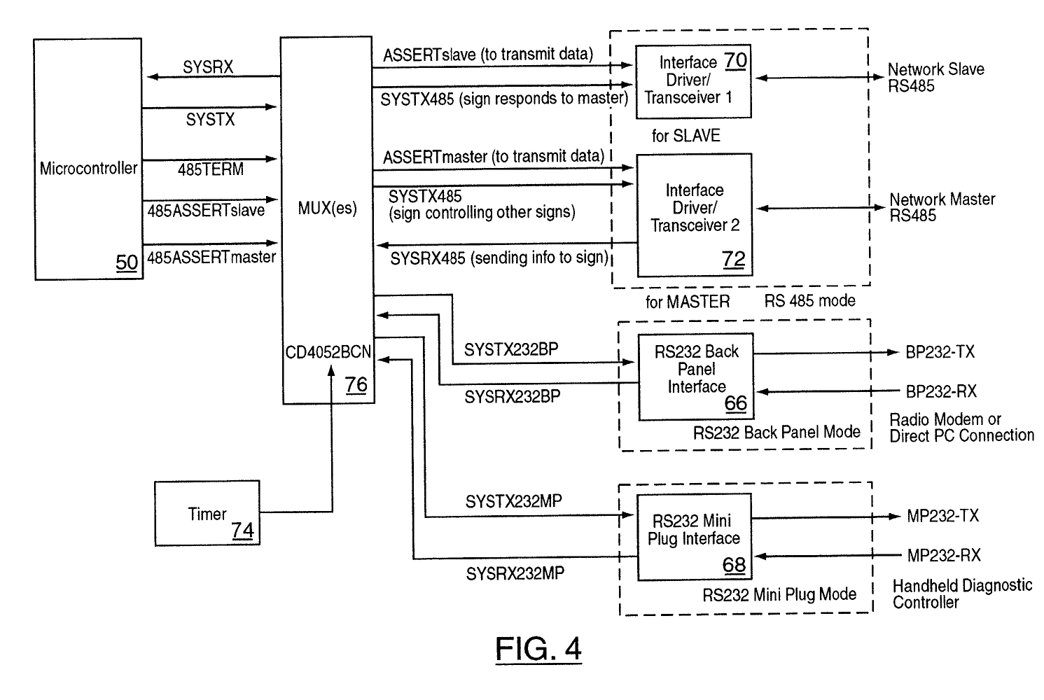

FIG. 4 illustrates the various network interfaces associated with microcontroller 50. As shown, the user can select three different methods of interfacing with microcontroller 50. The user can interface through a radio modem or a direct PC connection through the back panel of the network port RS232 interface 66. The second alternative is to interface using a handheld diagnostic controller through the mini plug of the network port RS232 interface 68. The third method is to communicate using the RS485 network slave and master interface 70 and 72. The RS485 network connection is the default mode for device 10.

Timer 74 (MM74HC123AN) is used to detect the presence of incoming data on the back panel interface 66 and mini plug port interface 68. Upon the detection of data on either of these two 232 port interfaces 66 or 68, timer 74 causes multiplexer 76 (preferably implemented by part number CD4052BCN) to switch the SYSRX and SYSTX lines over to the BP232 or MP232 port for approximately 500 ms. By doing so, the 485ASSERT lines are disabled. Data from a handheld controller takes precedence over all other control data. Thus, if data appears on the front-panel RS232 mini plug port interface 68, it will override all other ports, namely RS232 back panel interface 66 and RS485 interface 70 and 72 (i.e. RS485 and BP232 are disabled). Data from a radio or direct PC connection (i.e. RS232 back panel interface 66) takes precedence over the RS485 network interface 70 and 72. If data appears on the back panel RS232 interface 66, it will override the RS485 port interface 70 and 72 automatically. When no data is present on either RS232 port interface 66 or 68 for 500 ms, then all port selection circuits will time-out and the system reverts to the default RS485 port interface 70 and 72.

Multiplexer 76 routes both the SYSRX and SYSTX lines to one of the three hardware ports (i.e. RS485 network interface 70 and 72, RS232 back panel interface 66 or RS232 mini plug port interface 68). The SYSRX line receives incoming data, and the microcontroller transmits data out to other devices through the SYSTX line.

When the RS485 network interface 70 and 72 is used, substrate positioning device 10 can act in one of two modes. The first and most common operational mode is the substrate positioning device 10 acting as a slave and responding to incoming commands on the master RX line. These commands are sent via the SYSRX485 line of Transceiver 2, through the multiplexer 76 and then via the SYSRX line. If a received command requires substrate positioning device 10 to answer (e.g. to return status information), the response will be sent through the slave TX line. The 485ASSERTslave line enables transmission of the RS485 driver chip (SN75176BP) on the slave data line pair in order to transmit responses back to the master device. In such a case data will be transmitted via SYSTX, through multiplexer 76, and then through the SYSTX485 line of Transceiver 1.

The second operational mode is substrate positioning device 10 acting as a master to control other signs. In this case, it transmits the commands via the master TX line. The 485ASSERTmaster line enables transmission of the RS485 driver chip (part number SN75176BP) on the master data line pair in order to transmit master control data to other signs. The command is sent via SYSTX, through multiplexer 76, and via the SYSTX485 line of Transceiver 2.

When receiving incoming commands through the radio modem or direct PC connection, information is transmitted via the BP232-RX line, through the MAX232CPE driver/receiver, and then via SYSRX232BP, through multiplexer 76 and finally via SYSRX to microcontroller 50. For substrate positioning device 10 to respond, information is sent via the SYSTX line, through multiplexer 76, and via SYSTX232BP to the MAX232CPE driver/receiver and finally via the BP232-TX line. The same process occurs if sending or receiving commands via the RS232 mini plug interface 68 (with the exception that the MP232-TX/RX and SYSTX/RX232MP are used).

FIG. 5 illustrates two sample data records of the FRAME MARK POSITION table stored by microcontroller 50 in the case where there are only three frames on substrate 30 (i.e. frame numbers “0”, “1”, and “2”). Generally, substrate 30 contains a top frame, a bottom frame, and numerous middle frames. While in some cases there are no middle frames, there are never fewer than two frames. The leading edge of the top frame (i.e. frame number “0”) is set to an absolute value of 1000 increments as shown in the framemarker_edge record in FIG. 5. The framemarker_edge record contains information concerning the leading and trailing edge of a particular frame marker 38 as well as the calculated mark center. While the value of the leading edge of the top frame (i.e. frame number “0”) can be any value, it is preferable for the position integer not to become negative during computation, since all positional calculations are completed with unsigned math.

The framemarker_center record contains information relating to the center of the frame including the center of the mark (as calculated in the framemarker_edge record), the frame size and the resulting “window of opportunity” range discussed above. The window of opportunity is calculated as being + and −10% of the frame size for a particular pair of frames. The specific utility of the determined mark center and window of opportunity values will be further described below in reference to several of the computational routines executed by microcontroller 50.

The top frame (i.e. frame number “0”) is considered to be the origin. Since there are only three frames, there are only two frame sizes, namely the distance from frame “0” to frame “1”, and the distance from frame “1” to frame “2” It has been determined using the equipment of a conventional scrolling display, that a conventional 36 inch high frame is equivalent to 419 rotation increments, measured at the top substrate storage tube. As previously discussed, the use of additional frames will result in fewer rotation increments, because the diameter of the substrate roll increases and more frame material can wrap in a single revolution of substrate storage tube. When traveling up from frame “0” to frame “1”, the frame size “1” is used. When traveling down from frame “1” to frame “0”, the same frame “1” size is used, since travel is through the same physical space. If the sign moves below frame “2”, a long bottom end frame marker 38 (as previously discussed) will be detected by bottom sensor 14. If the sign moves above frame “0”, a long top end marker 38 will be detected by the top sensor 12. In either case, the END OF SCROLL DETECTION routine would be executed by microcontroller 50 as will be discussed.

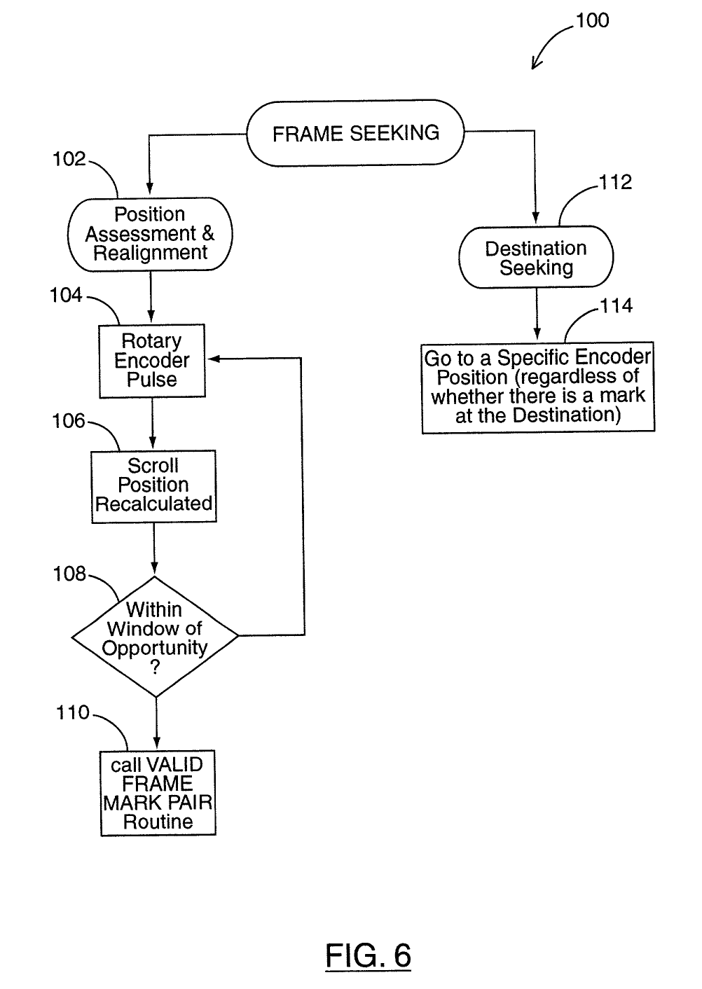

Referring now to FIGS. 1, 3, 4, and 6, a flowchart of the FRAME SEEKING routine 100 which is executed by microcontroller 50 when device 10 is seeking a valid frame marker 38 is specifically illustrated in FIG. 6. FRAME SEEKING routine 100 requires the concurrent execution of two processes, namely Position Assessment (starting at step 102) and Realignment and Destination Seeking (starting at step 112).

At step (102), the Position Assessment and Realignment process is initiated. Substrate 30 is considered to enter a “window of opportunity” when substrate 30 is reasonably within the range where frame markers 38 are expected to occur according to the originally performed learning process, as will be described. Microcontroller 50 first monitors to see whether substrate 30 has entered such a “window of opportunity” by waiting for the occurrence of a rotary encoder pulse at step (104). Each time there is a rotary encoder pulse, at step (106) microcontroller 50 recalculates the scroll position of substrate. Microcontroller 50 calculates the current position of substrate 30 by decoding the quadrature output of rotary encoder 16. The decoded electronic output of rotary encoder 16 provides a binary bit for direction-of-rotation and a pulse for each passage of a specified angle of rotation. Microcontroller 50 then translates these signals into an integer representing the position of the web material, or the ABSOLUTE POSITION INTEGER mentioned previously.

At step (108), microcontroller 50 checks the FRAME MARKER POSITION TABLE to see whether substrate 30 is within a “window of opportunity”. If so, then at step (110), the VALID FRAME MARK PAIR routine 200 is called. It should be noted that the “window of opportunity” is a configurable setup parameter and different tolerance ranges can be input for the “window of opportunity” for a particular device 10, as appropriate (i.e. in some cases it may be possible to have a narrow window of opportunity and accordingly will save processing steps, in others it may be necessary to conduct a higher amount of processing with a wider window).

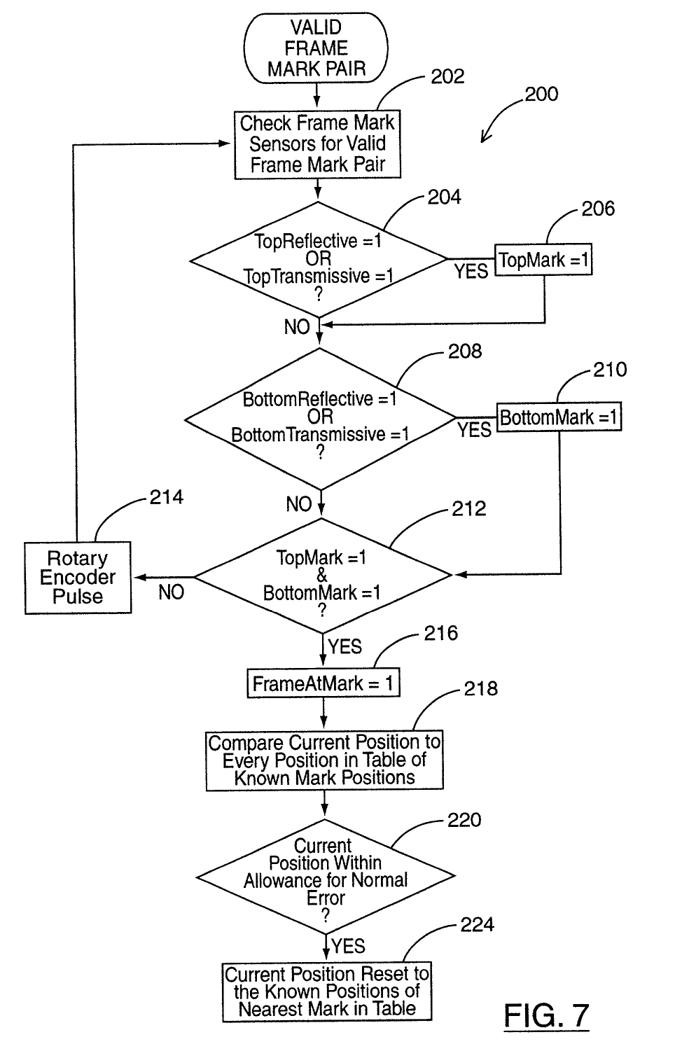

Referring now to FIGS. 1, 3, 4, and 7, a flowchart of the VALID FRAME MARK PAIR routine 200 which is executed by microcontroller 50 when substrate 30 has entered a window of opportunity is specifically illustrated in FIG. 7. Device 10 uses a redundant frame mark algorithm to reduce the likelihood of errors. Specifically, microcontroller 50 looks for two frame marks at separate locations that must align correctly to identify a frame position (i.e. portion of display art 37 to be displayed). Also, if optical sensing is used, two separate optical means, namely reflective and transmissive, are used to detect marks at each location.

At step (202), the top and bottom frame marker sensors 12 and 14 are checked to see if a valid frame mark pair 38 is present (i.e. a top mark and a bottom mark as identified by top frame sensor 12 and bottom frame sensor 14). Then a series of queries are initiated and each sensor provides a binary bit of information decoded by the system. First, at step (204), if TopReflective=1 OR TopTransmissive=1 then TopMark=1 (as performed by top frame sensor 12). Then at step (208), if BottomReflective=1 OR BottomTransmissive=1 then BottomMark=1 (as performed by bottom frame sensor 14). At step (210), if TopMark=1 AND BottomMark=1 then microcontroller 50 sets the variable FrameAtMark=1 to signify that a valid mark pair has been detected.

It should be noted that each Mark variable changes to the “set” state (i.e. =1) only once per frame. Also, this change of state occurs when the display art 37 is positioned within display 20 in an optimal viewing position (i.e. within viewing window A of FIG. 1). Finally, it is an implicit requirement that both Mark variables must change state at approximately the same time since there is only one optimal viewing position for each display art 37 frame.

At step (218), If a valid frame mark pair is detected, microcontroller 50 compares the current scroll position to each position in the FRAME MARK POSITION table, previously constructed through periodic learning processes. At step (220), if the result of the comparison indicates that the current position is within the allowance for normal error caused by slipping or varying roll tightness, then at step (224) the current position is reset to the known position of the nearest mark in the FRAME MARK POSITION table. This avoids positional error accumulated during the transit of display art 37.

Alongside the Position Assessment and Realignment process just discussed, FRAME SEEKING routine 100 at step (112) also concurrently runs the Destination Seeking process. At step (114), microcontroller 50 goes to a specific encoder position (e.g. the frame marker center position from the FRAME MARK POSITION table) regardless of whether there is a frame marker at that position. This process allows the device 10 to stop perfectly on frame positions that have corrupted marks without performing any hunting. Error corrections are made when adjacent marks are encountered. The presence or absence of marks has no effect on this routine. Another advantage of this routine is that it allows the system to accurately seek and land on positions other than marked positions, limited only by the incremental resolution of the quadrature rotary encoder.

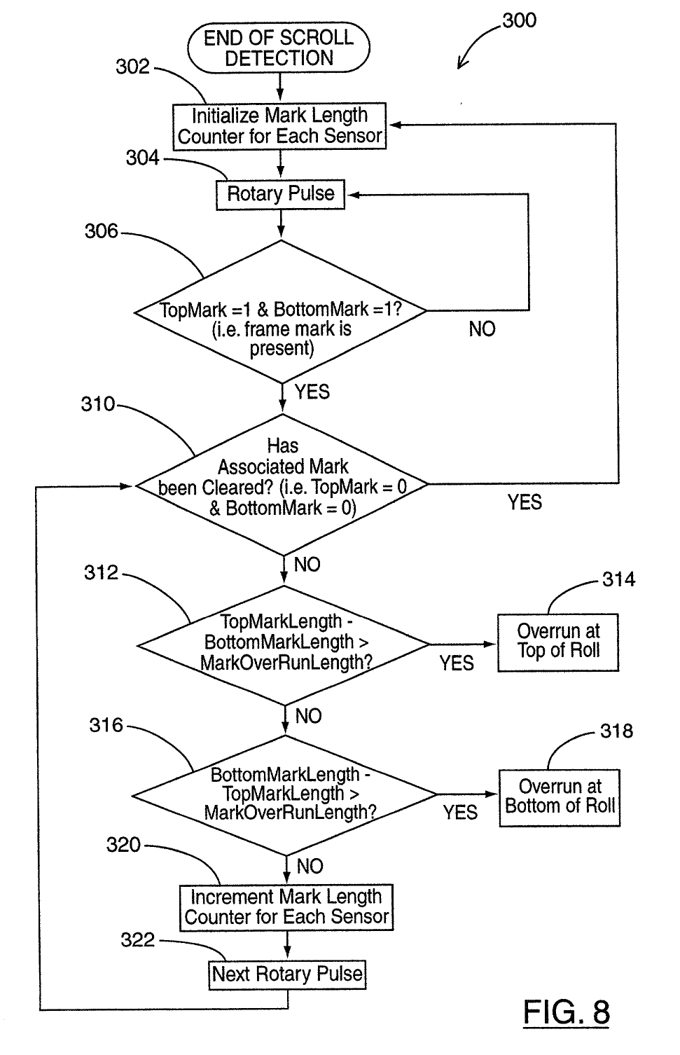

Referring now to FIGS. 1, 3, 4, and 8, a flowchart of the END OF SCROLL DETECTION routine 300 which is executed by microcontroller 50 in order to detect overrun at the end of substrate 30 is specifically illustrated in FIG. 8. This routine involves two mechanisms. First, due to the constant maintenance of the ABSOLUTE POSITION INTEGER, a properly configured and operating device 10 will generally stay within the limits of the FRAME MARK POSITION table and will not likely travel off the substrate storage tube 17, even if uncorrected cumulative positional error exists. The second mechanism involves a special frame marking system used to indicate the end-of-roll, regardless of current ABSOLUTE POSITION INTEGER. As discussed before, the first and last frame markers for substrate 30 (i.e. the top mark of the top frame and bottom mark of the bottom frame) on the scrolling substrate 30 are greater in length than the regular frame marks used throughout the body of the roll.

Microcontroller 50 utilizes a mark length counter for each sensor and the counter is initialized at step (302). Microcontroller 50 checks at each rotary pulse at step (304) to see whether a frame mark is present (i.e. determines if TopMark=1 AND BottomMark=1) at step (306). At steps (304) and (306), the mark length counter is incremented for each rotary encoder pulse until one of the following events occurs.

At step (310), microcontroller 50 determines whether the associated mark has cleared (i.e. ends), in which case the mark length counters are cleared. If not, then microcontroller 50 at step (312) checks to see if there has been an overrun at the top of the roll (i.e. by checking whether TopMarkLength−BottomMarkLength>MarkOverRunLength. If so, then microcontroller determines that there has been overrun at the top of substrate 30 (at step 314). If not, then at step (316), microcontroller 50 checks to see whether there is an overrun at the bottom of substrate 30 (i.e. by checking whether BottomMarkLength−TopMarkLength>MarkOverRunLength). The MARK LENGTH counter is incremented for each sensor at step (320) and the next rotary pulse is detected at step (322). If an overrun at either the top or bottom is detected by the above process, the microcontroller either (a) alerts the user or (b) corrects the substrate position to the nearest end frame and carries on with normal operation (described in greater detail below).

This detection mechanism ensures several conditions are met. First, marks of (i.e. approximately) equal length cannot trigger overrun detection. Second, mark length “differential” must cross a specific threshold (i.e. MarkOverRunLength) in order to be interpreted as an overrun (hysteresis). Finally, individual opacities (i.e. false marks such as dirt or advertising art symbols) are unlikely to cause the overrun counters to increment, since overrun counting is only initiated at a frame mark position (TopMark=1 AND BottomMark=1). False marks would have to occur at both sensor positions simultaneously and exceed the specified threshold length for overrun detection, which is unlikely.

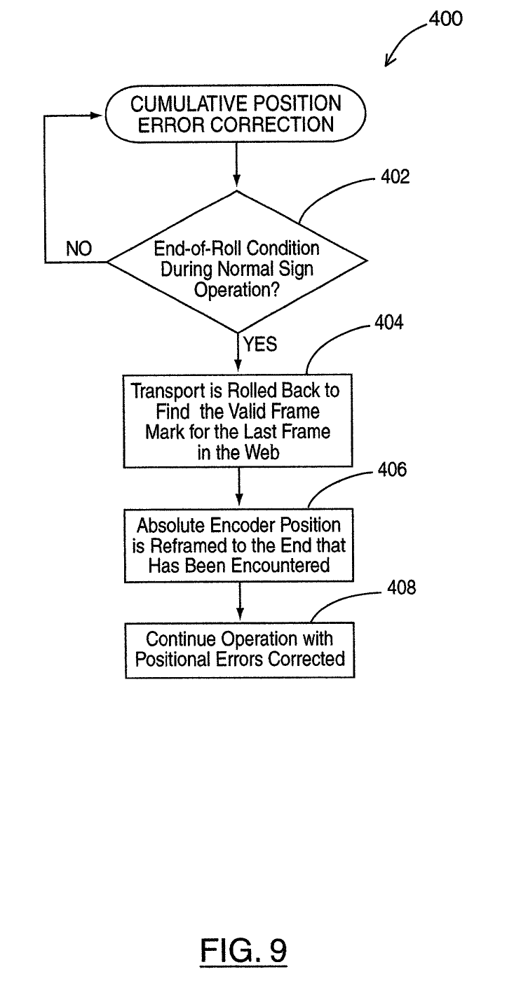

Referring now to FIGS. 1, 3, 4, and 9, a flowchart of the CUMULATIVE POSITION ERROR CORRECTION routine 400 which is executed by microcontroller 50 as an additional algorithm to help correct excessive cumulative positional error, is specifically illustrated in FIG. 9. Specifically, CUMULATIVE POSITION ERROR CORRECTION routine 400 deals with the situation where an end-of-roll condition has been encountered at step (402) by device 10 during (seemingly) ordinary display operation. At step (404), microcontroller 50 rolls back substrate 30 to find the valid frame mark for the last frame on the substrate 30. At step (406), microcontroller 50 uses data from the FRAME MARK POSITION table to reframe the absolute encoder position to the end-of-roll that has been encountered. At step (408), operation continues with position errors corrected. In this way, device 10 dynamically adjusts and corrects data within FRAME MARK POSITION table to ensure smooth and accurate operation.

The gain of substrate positioning device 10 is a factor of the distance between the current position and the target position on the substrate 30. Therefore, as the difference between the ABSOLUTE POSITION INTEGER and the position of the destination frame increases, the gain of the servo also increases. This way, maximum system responsiveness (and thus high gain) is ensured when the transport system is traveling long distances, and high stability and accuracy (low gain) is ensured when the web material is close to its final target position. For every rotary encoder pulse, the current position integer changes, and the relationship between the current position and target position is refreshed. Therefore, at high speeds, the rate of refresh is increased in order to improve stability. A timer-based minimum rate of refresh is also maintained, in order to ensure that a stall condition (where the rotary encoder is not turning) will be detected and escaped.

Fault detection is performed using several means. First of all, to detect faults in the rotary-encoder hardware, a time-out system is used. If control signals are applying enough power to the transport system to anticipate transport movement, and yet no rotary increments are detected within a specific time-out period, the system assumes that an unrecoverable fault has occurred and removes power from the transport system. Furthermore, if there is a fault in the power delivery system, this mechanism also causes a shutdown of the transport system. The software utilized by microcontroller 50 uses WDT (watchdog-timer) and COP (computer-operating-properly) techniques to ensure that the system is stable and running valid executable instructions. WDT/COP faults can occur as a result of power surges, static discharge or other circumstances beyond the control of the system designer, but are rare in general. However, if a WDT/COP fault does take place, a complete system reset will occur as a result within 64 ms of the software error.

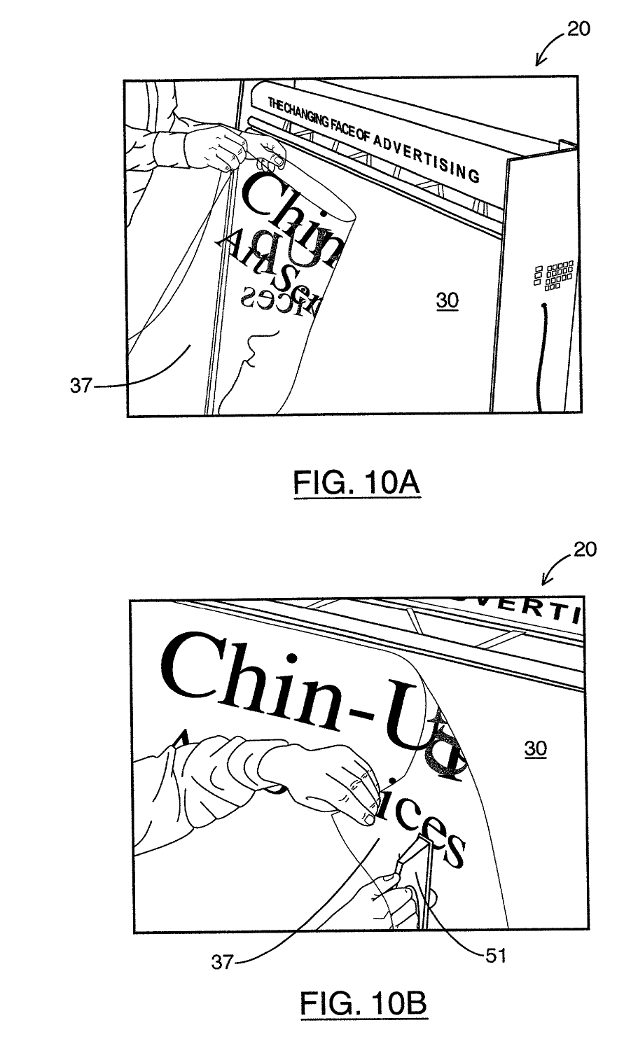

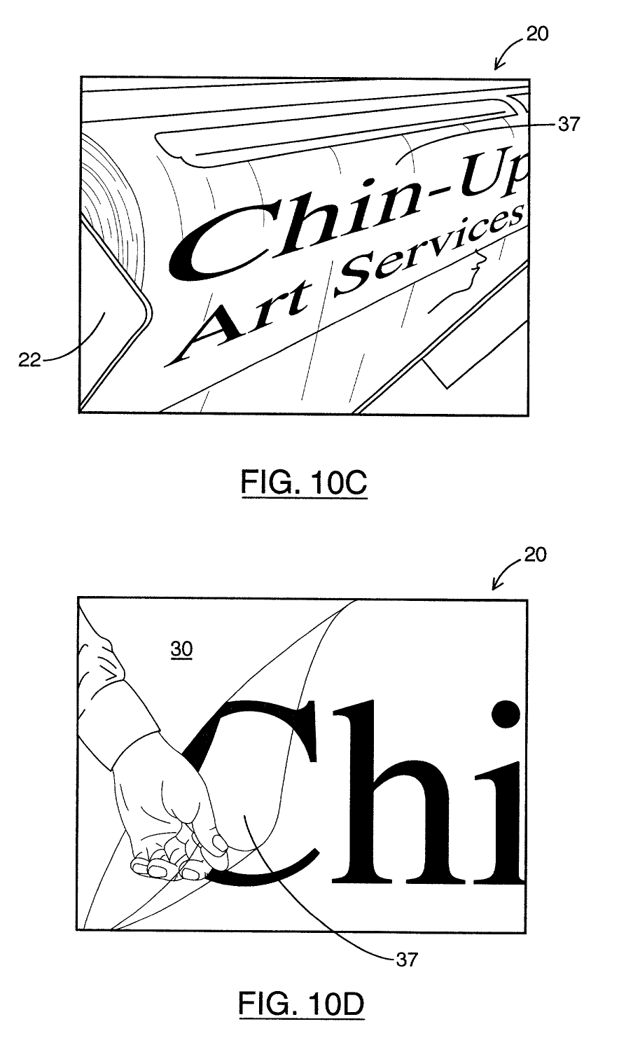

FIGS. 10A, 10B, 10C and 10D illustrate another aspect of the present invention, namely the method of providing sections of display art 37 for insertion and removal from substrate 30 using the ability to adhere individual sections of display art 37 to substrate 30 using the static cling properties of display art 37 and substrate 30. Most prior art scrollable display art systems utilize a web that is moved between two rollers where the display art is permanently installed on the substrate (i.e. is inserted and removed as a whole). The present invention allows display art 37 to be changed in any individual frame on substrate 30 by using a specially selected substrate 30 (i.e. a transparent material with a glossy exterior finish) and specially art 37 having specifically selected material qualities (i.e. non-adhesive cling material).

Specifically, FIG. 10A shows how cling material display art 37 adheres well to substrate 30 and the ease with which display art 37 may be installed on substrate 30. Once display art 37 is put into position over substrate 30 air bubbles can be pushed out using a soft tool 51 to rub cling material display (FIG. 10B). Cling material display art 37 can be adhered to substrate 30 with very little effort and cling material display art 37 is malleable enough to conform to changes in surface substrate characteristics as substrate 30 rolls on and off the storage rollers 22 and 24. Cling material display art 37 maybe repeatedly removed and reapplied, free of the handling difficulties associated with adhesives.

The preferred material for substrate 30 is a commercially available 5 gauge (0.005″ thickness) anti-static polyester film such as Mylar™, manufactured by Dupont. Polyester film has a number of qualities that make it conducive for application, namely dimensional stability, optical clarity, and anti-static formulation. Both substrate 30 and display art 37 must be thin gauge to allow installation of long roll lengths to maximize content and must remain dimensionally stable to avoid deformation of the substrate. As is conventionally known, deformation (i.e. stretch) will cause uneven travel from roll to roll, causing eventual edge-wear, art degradation and machine breakdown. Polyester film is extremely rigid on the x and y axis while remaining very easy to roll and its edges are strong and very resistant to tearing. Polyester film is also unaffected by temperatures in the normal range (−50 C to 75 C). Also, polyester film is optically clear to allow back-lighting to pass through to the art layer to enhance graphic quality. Polyester film has an optical opacity rating of 0.6% which is essentially clear and transparent.

Finally, as is conventionally known, display 20 can generate significant levels of static electricity when in operation. Static electricity can be harmful and disruptive to electronic circuitry within the sign. By using anti-static polyester film in substrate 30 and display art 37, the likelihood of static discharge is reduced for improved reliability of operation. It has been determined in testing, that in the case of more than 1,000,000 frame changes or transits, there has been no significant breakdown or degradation of the polyester film substrate 30.

FIG. 10C illustrates how once installed, cling material display art 37 is malleable enough to withstand curling on roller 22 and 24 without breaking cling adhesion. Display art 37 preferably consists of a commercially available cling film such as Arkwright Klear Kling Film™ upon which the graphic images are printed for subsequent installation in display 20. Cling film is typically composed of a Mylar base, an ink-jet receptive top coating for printing graphics, and a cling film type backing that allows it to adhere to the smooth surface of substrate 30. The advantages of polyester film as described above are incorporated into this graphic-print product by using polyester film as the manufacturing base. Dimensional stability and resistance to wear are common to both the substrate and the graphic material. This allows substrate 30 and display art 37 to form for practical purposes, one physical element, when installed, each with the same coefficient of expansion and resistance to deformation and stretch. With identical stresses in both materials there is no compromise in transport accuracy or longevity.

The cling coating on the back of display art 37 allows easy installation and repositioning in case of error. This material has an adhesive peel rating of 4+/−2 grams/cm per ASTM D3330, which is very low when compared to almost any common adhesive and it will de-laminate if left for too long on a tight radius. However, after each viewing period the graphic panel is effectively reinstalled due to the pressure that is applied through the movement onto the top or bottom roll during transit. This reinforces the bond between art panel and substrate, resulting in reliable performance without the need for an aggressive adhesive.

FIG. 10D illustrates the ease with which cling material display art 37 can be removed from display 20. Since there is no additional physical adhesive substance, display art 37 can be removed many years after installation without residue or the need for chemical cleaners, solvents or heat. When display art 37 has been removed, there is a perfectly clean and ready location on substrate 30 for a replacement panel. It has been determined that existing panels can be re-installed although both surfaces must be clean and free from oils to ensure successful reinstallation and that display art 37 itself can be re-used perhaps five times before it loses its ability to remain affixed to substrate 30 on a reliable basis. In all other respects, there is no damage to the graphic during the removal process.

As will be apparent to those skilled in the art, various modifications and adaptations of the structure described above are possible without departing from the present invention, the scope of which is defined in the appended claims.

1. A substrate positioning device for positioning a substrate within a substrate scrolling display having a display window, a substrate storage tube for storing the substrate and a motor driver coupled to the substrate storage tube for scrolling the substrate, such that a display art frame on the substrate is positioned within the display window, said substrate positioning device comprising:
(a) a rotary encoder coupled to the substrate storage tube for detecting the rotary position of the substrate storage tube;
(b) a controller coupled to said rotary encoder comprising:
(i) a memory for storing the rotary position of the substrate storage tube that corresponds to the position of the substrate when the display art frame is positioned within the display window;
(ii) a processor coupled to said memory programmed to access said rotary position in response to a request to display the display art frame within the display window;
(c) a display interface coupled to said controller for instructing the motor driver to rotate the substrate storage tube such that the display art frame is positioned within the display window.

2. The substrate positioning device of claim 1, wherein the display art frame contains first and second frame markers, and further comprising first and second frame sensors coupled to said controller for detecting said first and second frame markers, said processor being programmed to determine the rotary position of the substrate storage tube that corresponds to the position of the substrate when the first and second frame markers of the display art frame are detected and to store said rotary position in said memory.

3. The substrate positioning device of claim 1 wherein said rotary sensing device is a quadrature device.

4. The substrate positioning device of claim 2 wherein said first and second frame sensors are optical sensors, each comprising two infrared emitting diodes and an infrared receiver.

5. The substrate positioning device of claim 2 wherein said first frame marker is located at the top of the display art frame and the second frame marker is located at the bottom of the display art frame.

6. The substrate positioning device of claim 1 wherein said motor interface provides the signal in RS485 format.

7. The substrate positioning device of claim 1 wherein said motor interface provides the signal in RS232 format.

8. A method for positioning a substrate within a substrate scrolling display having a display window, a substrate storage tube for storing the substrate and a motor driver coupled to the substrate storage tube for scrolling the substrate, said method comprising the steps of:
(a) providing a substrate with a display art frame within said substrate scrolling display;
(b) storing the rotary position of the substrate storage tube that corresponds to the position of the substrate when the display art frame is positioned within the display window;
(c) retrieving said rotary position in response to a request to display the display art frame within the display window;
(d) adjusting the rotary position of the substrate storage tube such that the display art frame is positioned within the display window.

9. The method of claim 8, further comprising the additional steps of:
(e) applying first and second frame markers to said display art frame;
(f) detecting first and second frame markers such that the display art frame is positioned within the display window;
(g) determining the rotary position of the substrate storage tube when the first and second frame markers have been detected for storage and retrieval in steps (b) and (c).

10. The method of claim 8, wherein step (d) comprises instructing the motor driver to rotate the substrate storage tube.

11. The method of claim 10, wherein the motor driver is instructed using a signal in RS485 format.

12. The method of claim 10, wherein the motor driver is instructed using a signal in RS232 format.

13. The method of claim 9, wherein step (f) comprises detecting said first and second frame markers using optical sensors.

14. The method of claim 9, wherein step (g) comprises detecting the rotary position of the substrate storage tube using a quadrature rotary encoder.

15. The method of claim 9, wherein said first frame marker is located at the top of the display art frame and the second frame marker is located at the bottom of the display art frame.

16. A display art substrate assembly for use within a scrolling substrate display, said display art substrate assembly comprising:
(a) a substrate having a first coefficient of expansion and a first resistance to deformation, said substrate being adapted to be moveable within said scrolling display; and
(b) a removeable display art sheet for attachment to said substrate, said removeable display art sheet having a second coefficient of expansion which is substantially equal to the first coefficient of expansion of said substrate and a second resistance to deformation which is substantially equal to the first resistance to deformation of said substrate;
such that when said removeable display art sheet is brought into close contact with said substrate, substantially identical stresses are produced within said substrate and said removable display art sheet and substantial cling adhesion is produced therebetween.

17. The assembly of claim 16, wherein said substrate has an optical opacity rating of substantially 0.6%.

18. The assembly of claim 16, wherein said removeable display art sheet is comprised of a base, an ink receptive top coating positioned on top of said base and a cling film backing positioned under said base which is adapted to adhere to said substrate.

19. The assembly of claim 16, wherein said substrate is comprised of antistatic polyester film.

20. The assembly of claim 16, wherein said removeable display art sheet is comprised of antistatic polyester film.

21. The assembly of claim 16 in combination with a tool having a soft surface for removing air bubbles from between said substrate and said removeable display art sheet.
